(19) United States
(12) Patent Application Publication
(10) Pub. No.: US 2023/0195076 A1
(43) Pub. Date: Jun. 22, 2023

(54) STORAGE MEDIUM TO STORE DATA DISPLAY CONTROL PROGRAM, DATA DISPLAY CONTROL METHOD, AND DATA DISPLAY CONTROLLER

(71) Applicant: Mitsubishi Electric Corporation, Tokyo (JP)

(72) Inventor: Koji MORITA, Tokyo (JP)

(73) Assignee: Mitsubishi Electric Corporation, Tokyo (JP)

(21) Appl. No.: 17/927,896

(22) PCT Filed: Jun. 10, 2020
(86) PCT No.: PCT/JP2020/022911

§ 371 Date: Nov. 28, 2022

(51) Int. Cl. G05B 19/408; G06F 3/14

(52) U.S. Cl. CPC G05B 19/408; G06F 3/14; G05B 2219/37084

(57) ABSTRACT

A data display control program causes a computer to execute: a storing step in which a storage device stores first and second data, the first data being data related to a manufacturing device in operation and being time series data for a period of time including a first date and time; a first display step in which a first display tool causes the first data and a first marking position indicating a second date and time designated to be displayed in a first display area; and a second display step in which a second display tool causes the second data to be displayed in a second display area, reads first marking information from the storage device, and causes the first marking position indicating the second date and time to be displayed in the second display area.

### FIELD

The present disclosure relates to a data display control program, a data display control method, and a data display controller for displaying data. that changes over time.

### BACKGROUND

A data display controller acquires data on a device in operation. and displays the data on a display device in order to check data at. the time of occurrence of a failure in the device. The data display controller acquires, for example, logging data, which is logged control data on the device, and allows display of the logging data. This allows a user to analyze the cause of the failure in the device, etc., viewing the displayed data.

An engineering tool described in Patent Literature 1 temporally synchronizes a plurality of types of data such as a waveform indicating a change in logging data and a program controlled state, and allows the plurality of types of data linked with one another to be sequentially displayed as time elapses. Accordingly, a user checks data be wishes to focus attention on from among the plurality of types of data linked with one another and displayed by the engineering tool.

### CITATION LIST

### Patent Literature

Patent Literature 1: International Publication No. WO 2014/167726

### SUMMARY

### Technical Problem

For the technique of Patent Literature 1 above, unfortunately, the user, who desires to check again the data having been checked once, needs to display, again, the plurality of types of data linked with one another. This results in a problem. of taking time and effort to search for the data desired by the user.

The present disclosure has been made in view of the above, and an object thereof is to provide a data display control program that allows easy display of data desired by a user among a plurality of types of data that changes over time.

### Solution to Problem

In order to solve the above problem and achieve the object, a data display control program of the present disclosure causes a computer to execute a storing step in which a storage device stores first data and second data, the first data being data related to a manufacturing device in operation, and being time series data for a period of time including a first date and time. The data display control program of the present disclosure also causes the computer to execute: a first display step in which a first display tool causes the first data to be displayed in a first display area and, when. a second date and time is designated, causes a first marking position indicating the second date and time to be displayed in the first display area; and a first registration step in which the first display tool registers first marking information related to the first marking position, in the storage device. The data display control program of the present disclosure also causes the computer to execute a second display step in which a second display tool causes the second data to be displayed in a second display area, reads the first marking information from the storage device, and causes the first marking position indicating the second date and time to be displayed. in the second display area.

### Advantageous Effects of Invention

The data display control program according to the present disclosure allows for easy display of the data desired. by the user among the plurality of types of data that changes over time.

### BRIEF DESCRIPTION OF DRAWINGS

FIG. 1 is a diagram illustrating a configuration of a data display system. including a. data display controller according to an embodiment.

FIG. 2 is a table illustrating a configuration. of first marking information used by the data display controller according to the embodiment.

FIG. 3 is a diagram illustrating an example of a program screen displayed. under the control of the data display controller according to the embodiment.

FIG. 4 is a diagram illustrating an example of a waveform screen. displayed under the control of the data display controller according to the embodiment.

FIG. 5 is a diagram illustrating an example of a video screen displayed under the control of the data display controller according to the embodiment.

FIG. 6 is a diagram for explaining marking positions linked with one another by the data display controller according to the embodiment.

FIG. 7 a flowchart illustrating a display processing procedure for a video display tool according to the embodiment to display a marking position.

FIG. 8 is a flowchart illustrating a display processing procedure for a program display tool according to the embodiment to display a marking position.

FIG. 9 is a flowchart illustrating a detailed processing procedure for step S140 of FIG. 7 and step S240 of FIG. 8.

FIG. 10 is a flowchart illustrating a detailed. processing procedure for step S130 of FIG. 7 and step S230 of FIG. 8.

FIG. 11 is a diagram for explaining a marking position to be added or deleted by the data display controller according to the embodiment.

FIG. 12 is a diagram for explaining how the data display controller according to the embodiment registers a comment for a marking position.

FIG. 13 is a diagram for explaining processing for the data display controller according to the embodiment to display a registered marking position.

FIG. 14 is a diagram for explaining search processing executed by the data display controller according to the embodiment.

FIG. 15 is a diagram for explaining a processing result of the search processing executed by the data display controller according to the embodiment.

FIG. 16 is a diagram illustrating an example of a hardware configuration for implementing the data display controller according to the embodiment.

### DESCRIPTION OF EMBODIMENT

A data display control program, a data display control method, and a data display controller according to an embodiment of the present disclosure will be hereinafter described in detail with reference to the drawings.

### Embodiment

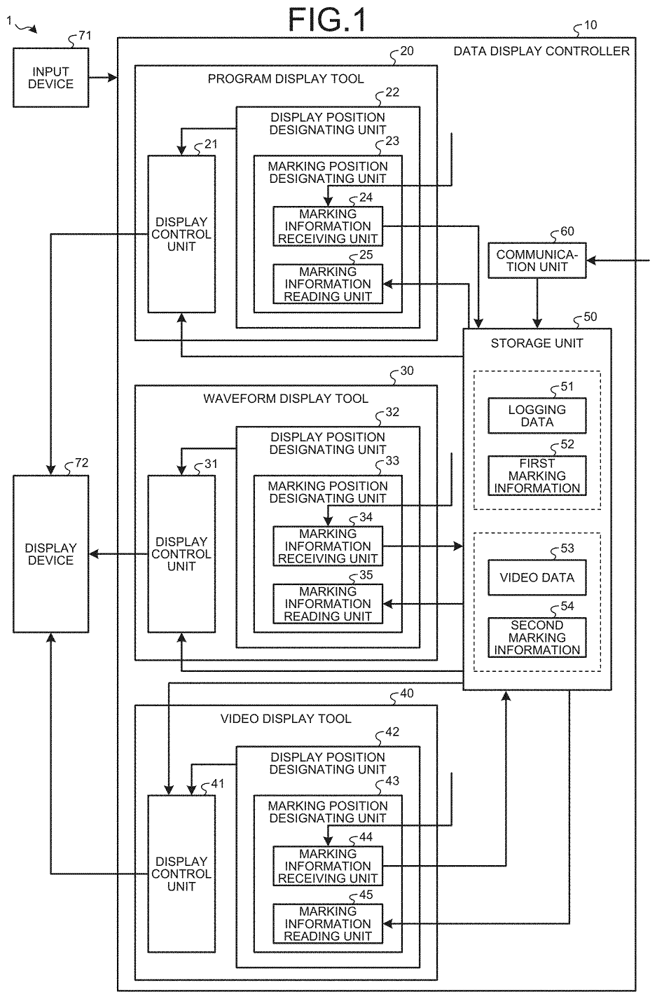

FIG. 1 is a diagram illustrating a configuration of a data display system including a data display controller according to an embodiment. A data display system 1 is a system that displays a plurality of types of data acquired from a device at a manufacturing site (hereinafter referred to as a manufacturing device) or the like. The data display system 1 displays, for example, a waveform indicating a change in logging data 51, which is logged control data on a device, a controlled state indicated by the logging data 51, and a video of the device. The controlled state indicated by the logging data 51 is represented by a logging data value on a control program. used for controlling the manufacturing device.

The logging data 51, which is trace data, is data having a time of acquisition and an internal data value (a value of device data associated with each other index by index. The index corresponds to a unit time of sampling. The internal data is stored in. a storage unit of a controller such as a p,programmable controller that controls the manufacturing device. The internal data value is, for example, arithmetic processing information indicating a value acquired from an input device connected. to the controller of the manufacturing device or a value output to an output device connected. to the controller of the manufacturing device.

The plurality of types of data displayed by the data display system 1 may be data of different dates and times. That is, the data display system 1 may simultaneously display the waveform data at a first timing, the controlled state by the control program at a second timing, and the video at a third timing. In other words, the data display system 1 need not link the dates and times of the plurality of types of data displayed.

The data display system 1 includes a data display controller 10, an input device 71, and a display device 72. The input device 71 is a device for inputting :information. to the data display controller 10. The input device 71 is, for example, a mouse and a keyboard.

The data display controller 10 is a computer that causes the display device 72 to display various kinds of data in accordance with the information input by the input device 71. The display device 72 is a device that displays the data transmitted from the data display controller 10. The display device 72 is, for example, a liquid crystal monitor.

The data display controller 10 includes a program display tool 20, a waveform display tool 30, and a video display tool 40. The data display controller 10 further includes a communication unit 60 and a storage unit 50 that is a storage device.

The communication unit 60 receives the logging data 51 and video data 53 from the manufacturing device or the like. The logging data 51 is the data obtained by logging the control data on the manufacturing device. The logging data 51 includes information on temporal transition of a state of a program used in controlling the manufacturing device (the program being hereinafter referred to as a device control program). Examples of the device control program include a ladder program written in a ladder language, and a program written in a structured text (ST) language, a function block diagram (FBD) language, a sequential function chart (SIFC) language, or the like. The logging data 51 also includes information on temporal transition of an internal data value of the device control program, that is, a logging data value. The video data 53 is a video presenting the operation of the manufacturing device and a workpiece imaged by an imaging device such as a camera. The video data 53 is a set of a plurality of images, and in the video data. 53, time information provided by an internal clock of the imaging device is associated with the images.

The communication unit 60 stores, in the storage unit 50, the received, logging and video data 51, 53. The storage unit 50 is a memory or the like that stores various kinds of data used by the data display controller 10. The storage unit 50 stores the logging data 51, first marking information 52, the video data 53, and second marking information 54.

The first marking information 52 is information related to a marking position set in the logging data 51. The first marking information 52 is information indicating a specific date and time in the logging data 51. The first marking information 52 is created by the program display tool 20 and the waveform display tool 30. The marking information may include additional information as will be described later in addition to the information related to the date and time of the data designated for marking.

The second marking information 54 is information related to a marking position set in the video data 53. The second marking information 54 is information indicating a specific date and time in the video data 53. The second marking information 54 is created by the video display tool 40.

The program display tool 20, which is a circuit monitoring tool, uses the logging data 51 to thereby cause the display device 72 to display the device control program and the internal data value that is a state of the device control program. The device control program has a part (hereinafter referred to as a specified program area) to be displayed on the display device 72, and the program display tool 20 has a function of changing the specified program area of the device control program. That is, the program display tool 20 can change which area of the device control program is to be displayed on the display device 72. The program display tool 20 also has a function of causing the display device 72 to display a seek bar together with the specified program area. The seek bar displayed by the function of the program display tool 20 is hereinafter referred to as a program seek bar.

The program display tool 20 causes the display device 72 to display the specified program area corresponding to a date and time designated by a user (hereinafter referred to as a user-designated position) on the program seek bar. At this time, the program display tool 20 causes the display device to display the internal data value, that is, a monitor value, as the controlled state of the specified program area at the user-designated position. Examples of the internal data value include turning on or off of a device, a device value, and the like. The device, which is an element included in the device control program, includes, for example, an internal relay, an. input contact, an output coil, a data register, and the like. In the device control program, the internal relay, the input contact, and the output coil are turned on or off, and the device values are stored in the data register. The specified program area includes one or a plurality of program blocks, each of which includes an instruction word. By using the program display tool 20, the user can check a control logic, changing the internal data value of the control program.

When receiving input of a marking position on the program seek bar from the user or extracting a marking position from the second marking information 54, the program display tool 20 registers the marking position in the first marking information 52. The marking position is time information indicated by a date and time. The marking position is also registered in the first marking information 52 by the waveform display tool 30. The program display tool 20 displays, on the program seek bar, the marking position registered in. the first marking information 52 and the marking posit ion input by the user.

In addition, the program display tool 20 deletes a marking position, which the user has instructed the program display tool 29 to delete, from the program seek bar and from the first marking information 52. The program display tool 20 and the waveform display tool 30 designate the marking position by designating an index. included in the logging data 51.

The program display tool 20 includes a display control unit 21 and a display position designating unit 22. The display position designating unit 22 includes a marking position designating unit 23, and the marking position designating unit 23 includes a marking information receiving unit 24 and a marking information reading unit 25.

The display control unit 21 reads the logging data 51 from the storage unit 50, and generates the device control program corresponding to the logging data. 51 and the program seek bar. The display control unit 21 causes the display device 72 to display the generated device control program and the generated program seek bar. The display control unit 21 further causes the display device 72 to display, for example, the specified program area, the marking position, the user-designated position, or the like in accordance with an instruction from the display position designating unit 22.

The display position designating unit 22 instructs the display control unit. 21 of a display, position of information to be displayed. on the display device 72. The marking position designating unit 23 instructs the display control unit 21 of the marking position to be displayed. on the display device 72.

The marking information reading unit 25 reads the first marking information 52 from the storage unit 50 and transmits, to the display control unit 21, the marking position stored. in the first marking information 52. The marking information reading unit 25 also reads the second marking information 54 from the storage unit 50 and transmits, to the display control unit 21, the marking position stored in the second marking information 54.

Moreover, the marking information reading unit 25 extracts information not included in the first marking information 52 from the information included in the second marking information 54. The marking information reading unit 25 registers the extracted information in the first marking information 52.

The first marking information 52 is thus updated. Similarly, the second marking information 5-1 is updated In a case where the second marking information 54 is newer than the first marking information 52, that is, updated later than the first marking information 52, the marking information reading unit 25 extracts information not included in the second marking information 54 from the information included in the first marking information 52. The extracted information is information having been deleted from the second marking information 54.

When detecting a marking position having deleted from the second marking information 54, therefore, the marking information reading unit 25 transmits this marking position to the display control unit 21 and deletes the marking position from the first marking information 52.

The marking information receiving unit 24 receives the marking position input by the user to the input device 71, and registers the marking position in the first marking information 52. Moreover, the marking information receiving unit 24 transmits the received marking position to the display control unit 21.

The waveform display tool 30 is a tool that uses the logging data 51 to thereby cause the display device 72 to display a waveform of the internal data value in the device control program. The waveform of the internal data has a part (hereinafter referred to as a specified waveform area) to be displayed on the display device 72, and the waveform display tool 30 has a function of changing the specified waveform area of the waveform of the internal data. That is, the waveform display tool 30 can change which area of the device control program is to be displayed on the display device 72. The waveform display tool 30 also has a function of causing the display device 72 to display a marking position together with the specified waveform area.

The waveform display tool 30 causes the display device 72 to display the specified waveform area corresponding to a user-designated position designated by a user. When receiving input of a marking position from the user or extracting a marking position from the second marking information 54, the waveform display tool 30 registers the marking position in the first marking information 52. The waveform display tool 30 displays, on the waveform, the marking position registered in the first marking information 52 and the marking position input by the user. In addition, the waveform display tool 30 deletes a marking position, which the user has instructed the waveform display tool 30 to delete, from the waveform and the first marking information 52 as well.

The waveform display tool 30 includes a display control unit 31 and a display position designating unit 32. The display position designating unit 32 includes a marking position designating unit 33, and the marking position designating unit 33 includes a marking information receiving unit 34 and a marking information reading unit 35.

The display control unit 31 reads the logging data 51 from the storage unit 50, and generates the waveform corresponding to the logging data 51. Moreover, the display control unit 31 causes the display device 72 to display various kinds of data in accordance with an instruction from the display position designating unit 32. The display control unit 31 causes the display device 72 to display, for example, the specified waveform area, the marking position, the user-designated position, or the like.

The display position designating unit 32 instructs the display control unit 31 of a display position of information to be displayed on the display device 72. The marking position designating unit 33 instructs the display control unit 31 of the marking position to be displayed on the display device 72.

The marking information reading unit 35 reads the first marking information 52 from the storage unit 50 and transmits, to the display control unit 31, the marking position stored in the first marking information 52. The marking information reading unit 35 also reads the second marking information 54 from the storage unit 50 and transmits, to the display control unit 31, the marking position stored in the second marking information 54.

Moreover, the marking information reading unit 35 extracts information not included in. the first marking information 52 from the information included in the second marking information 54. The marking information reading unit 25 registers the extracted information in the first marking information 52.

In a case where the second marking information 54 is newer than the first marking information 52, that is, updated later than the first marking information 52, the marking information reading unit 35 extracts information not included in the second marking information 54 from the information included in the first marking information 52. The extracted information is information having been deleted from the second marking information 54.

When detecting a marking position that has been deleted from the second marking information 54, therefore, the marking information reading unit 35 transmits this marking position to the display control unit 31 and deletes the marking position from the first marking information 52.

The marking information receiving unit 34 receives the marking position input by the user to the input device 71, and registers the marking position in the first marking information 52. Moreover, the marking information receiving unit 34 transmits the received marking position to the display control unit 31.

The video display tool 40 is a tool that uses the video data 53 to thereby cause the display device 72 to display a video. The video display tool 40 has a function of causing the display device 72 to display a seek bar together with the video. The seek bar displayed by the function of the video display tool 40 is hereinafter referred to as a video seek bar.

The video display tool 40 causes the display device 72 to display a video corresponding to a user-designated position designated by a user on the video seek bar.

When receiving input of a marking position on the video seek bar from the user or extracting a marking position from the first marking information 52, the video display tool 40 registers the marking position in the second marking information 54. The video display tool 40 displays, on the video seek bar, the marking position registered in the second marking information 54 and the marking position input by the user. In addition, the video display tool 40 deletes a marking position, which the user has instructed the video display tool 40 to delete from the video seek bar and the second marking information 54 as well.

The video display tool 40 includes a display control unit 41 and a display position designating unit 42. The display position designating unit 42 includes a marking position designating unit 43, and the marking position designating unit 43 includes a marking information receiving unit 44 and a marking information reading unit 45.

The display control unit 41 reads the video data 53 from the storage unit 50, and generates the video seek bar corresponding to the video data 53. The display control unit 41 causes the display device 72 to display the video data 53 and the video seek bar. Moreover, the display control unit 41 causes the display device 72 to display a video in accordance with an instruction from the display position designating unit 42. The display control unit 41 further causes the display device 72 to display, for example, a video, a marking position, a user-designated position, or the like in accordance with an instruction from the display position designating unit 42.

The display position designating unit 42 instructs the display control unit 41 of a display, position of information to be displayed on the display device 72. The marking position designating unit 43 instructs the display control unit 41 of the marking position to be displayed on the display device 72.

The marking information reading unit 45 reads the second marking information 54 from the storage unit 50 and transmits, to the display control unit 41, the marking position stored in the second marking information 54. The marking information reading unit 45 also reads the first marking information 52 from the storage unit 50 and transmits, to the display control unit 41, the marking position stored in the first marking information 52.

Moreover, the marking information reading unit 45 extracts information not included in the second marking information 54 from the information included in the first marking information 52. The marking information reading unit 45 registers the extracted information in the second marking information 54.

The second marking information 54 and the first marking information 52 are thus updated. In a case where the first marking information 52 is newer than the second marking information 54, that is, updated later than the second marking information 54, the marking information reading unit 45 extracts information not included in the first marking information 52 from the information included in the second marking information 54. The extracted information is information having been deleted from the first marking information 52.

When detecting a marking position having been deleted from the first marking information 52, therefore, the marking information reading unit 45 transmits the marking position to the display control unit 41 and deletes the marking position from the second marking information 54.

The marking information receiving unit 44 receives the marking position input by the uses to the input device 71, and registers the marking position in the second marking information 54. Moreover, the marking information receiving unit 44 transmits the received marking position to the display control unit 41.

Note that each of the program display tool 20, the waveform display tool 30, and the video display tool 40 has a reproduction function of playing data at a specific speed. Each of the tools may also have a frame advance function, a pause function, a fast-forward function, a rewind function, and the like. Moreover, each of the tools may have a jump function of allowing data of a marking position being displayed to jump to a marking position of a next date and time.

In a case where the program display tool 20 is a first display tool, or in a case where the waveform display tool 30 is the first display tool, the logging data 51 is first data, and the video data 53 is second data. In a case where the video display tool 40 is the first display tool, the video data 53 is the first data, and the logging data 51 is the second data.

Note that a plurality of the display devices 72 may be provided. For example, in the presence of three display devices 72, the program display tool 20 causes the first display device 72 to display data, the waveform display tool 30 causes the second display devices 72 to display data, and the video display tool 40 causes the third display devices 72 to display data.

Moreover, the data display system 1 may execute processing 1) to processing 4 below in any order.

(Processing 1) The first display tool causes display of a marking position designated by a user.

(Processing 2) A second display tool causes display of a marking position designated by a user.

(Processing 3) The first display tool. reads a marking position from the storage unit 50 and causes the marking position to be displayed.

(Processing 4) The second display tool reads a marking position from the storage unit 50 and causes the marking position to be displayed.

As described above, in the data display system 1, the first display tool causes display of a first marking position, which is the user-designated marking position of the first data, and registers the first marking position in the storage unit 50, and the second display tool causes the first marking position to be displayed. In this case, the second display tool may or need not display a second marking position that is the user-designated marking position of the second data. The second display tool may or need not register the second marking position in the storage unit 50. Also, the first display tool may or need not display the second marking position.

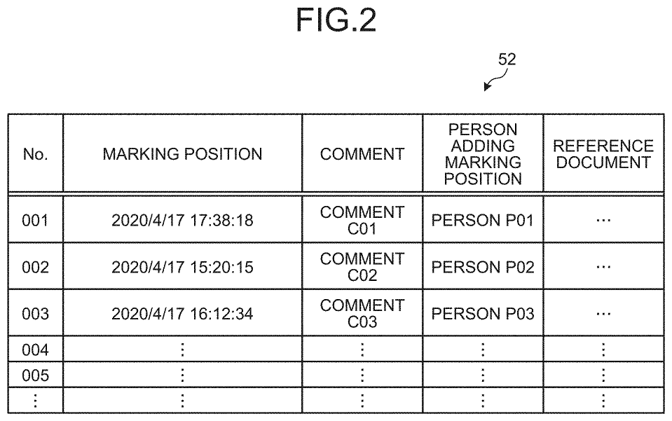

FIG. 2 is a table illustrating a configuration of the first marking information used by the data display controller according to the embodiment. Note that the second marking information 54 has a configuration similar to that of the first marking information 52, and thus will not be described.

The first marking information 52 is information having an identification number, a marking position, a comment, a person adding marking position, and a reference document associated with one another. The identification number is information that identifies the marking position.

The marking position is a position of the marking added by a user, and is indicated by a date and time.

The comment is a comment input by a user for the marking position. The person adding marking position is information that identifies a user who has added the marking position. The reference document is a name of a document associated with the marking position by a user. The comment, the person adding marking position, and the reference document are the additional information for the marking position.

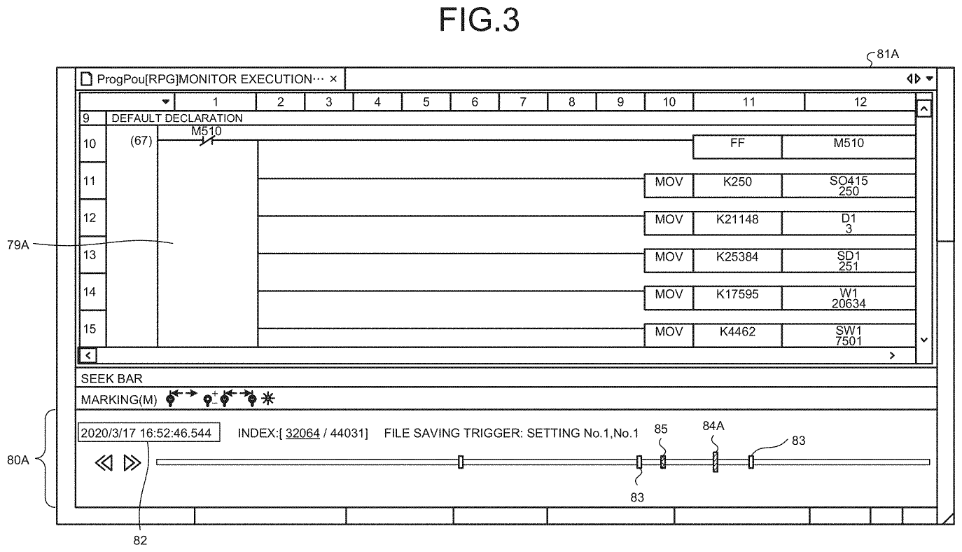

FIG. 3 is a diagram illustrating an example of a program screen displayed under the control of the data display controller according to the embodiment. A program screen 81A displayed by the display device 72 includes a specified program area 79A, a program seek bar 80A, and a date and time display area 82. A marking position 83, a user-designated position 84A, and a trigger position 85 are displayed in the program seek bar 80A. The display device 72 may display one or a plurality of the marking positions 83. The trigger position 85 is information indicating a timing at which an anomaly occurs in the manufacturing device. The date and time display area 82 is an area that displays a date and time corresponding to the specified program area 79A. The date and time displayed in the date and time display area 82 corresponds to the user-designated position 84A.

When an anomaly occurs in the manufacturing device, the logging data 51 before and after the occurrence of the anomaly is sent to the data display controller 10. A user can analyze the cause of the failure that has occurred in the manufacturing device and the like by checking the specified program area 79A, a specified waveform area 79B (to be described), and a video display area 79C (to be described) of the manufacturing device before and after the trigger position 85.

A user can designate the marking position 83 and the user-designated position 84A by designating a position on the program seek bar 80A. Also, by changing the user-designated position 84A, the user can change the specified program area 79A such that the specified program area 79A of a date and time corresponding to the user-designated position 84A is displayed on the program screen 81A.

When a user inputs an instruction to add the marking position 83 to the input. device 71 with the display device 72 displaying a specified program area 79A, the program display tool 20 registers a date and time corresponding to that displayed specified program area 79A, as the marking position 83 in the first marking information 52.

When a user inputs an instruction to delete the marking position 83 to the input device 71 with the display device 72 displaying a specified program area 79A, the program display tool 20 deletes the marking position 83 of a date and time corresponding to that displayed specified program area 79A, from the first marking information 52.

Note that a user may set a specific position on the program seek bar 80A as the marking position 83 without designating the user-designated position 84A. In this case, the program display tool 20 registers a date and time corresponding to the specific position designated as the marking position 83, in the first marking information 52. The user may also delete the marking position 83 from a specific position on the program seek bar 80A without designating the user-designated position 84A. In this case, the program display tool 20 deletes the marking position 83 of a date and time corresponding to the specific position designated, from the first marking information 52.

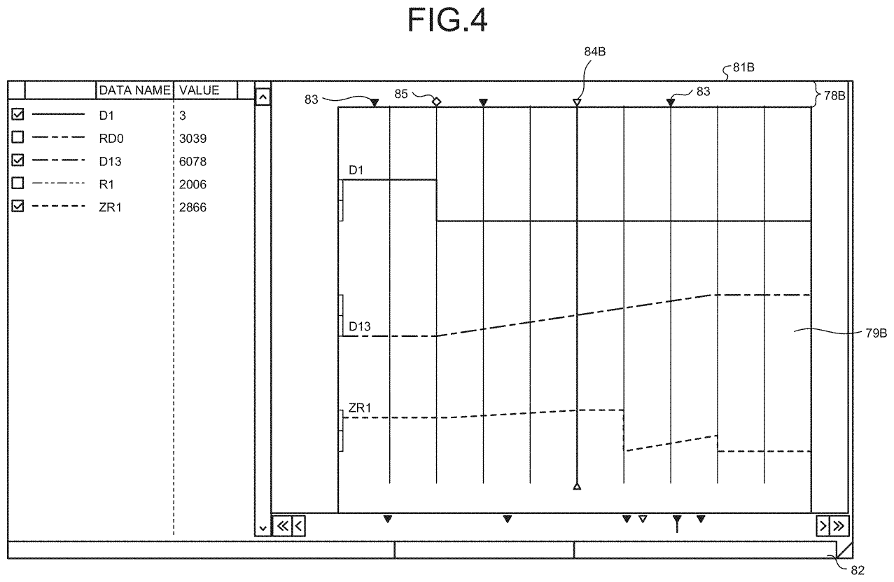

FIG. 4 is a diagram illustrating an example of a waveform screen displayed under the control of the data display controller according to the embodiment. A waveform screen 81B displayed by the display device 72 includes the specified waveform area 79B, a mark display area 78B, and the date and time display area 82. The mark display area 78B is an area that displays the marking position 83, a user-designated position 84B, and the trigger position 85.

A user can designate the marking position 83 and the user-designated position 84B by designating a position on the waveform screen 81B. Also, by changing the user-designated position 84B, the user can change the specified waveform area 79B such that the specified waveform area 79B of a date and time corresponding to the user-designated position 84B is displayed on the waveform screen 81B. For example, the data display controller 10 causes the waveform screen 81B to display a slide bar, and allows the user to change the specified waveform area 79B, using the slide bar.

When a user inputs an instruction to add the marking position 83 to the input device 71 with the display device 72 displays a specified waveform area 79B, the waveform display tool 30 registers a date and time corresponding to that displayed specified waveform area 79B, as the marking position 83 in the first marking information 52.

When a user inputs an instruction to delete the marking position 83 to the input device 71 with the display device 72 displaying a specified waveform area 79B, the waveform display tool 30 deletes the marking position 83 of a date and time corresponding to that displayed specified waveform area 79B, from the first marking information 52.

Note that, as in the case of the program display tool 20, a user may add or delete the marking position 83 by designating a specific position on the mark display area 78B.

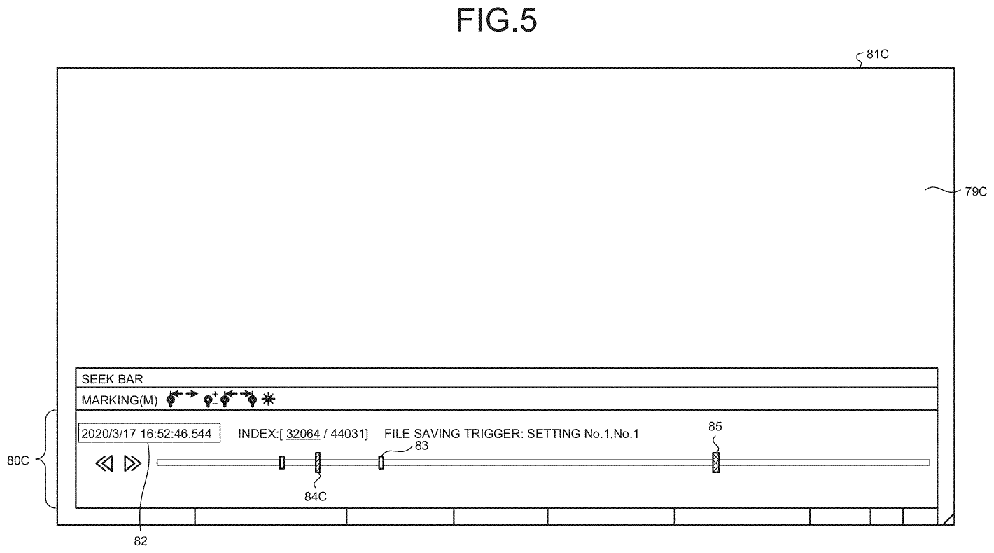

FIG. 5 is a diagram illustrating an example of a video screen displayed under the control of the data display controller according to the embodiment. A video screen 815 displayed by the display device 72 includes the video display area 79C, a video seek. bar 80C, and the date and time display area 82. The marking position 83, a user-designated position 84C, and the trigger position 85 are displayed in the video seek bar 80C.

A user can designate the marking position 83 and the user-designated position 84C by designating a position on the video seek bar 80C. Also, by changing the user-designated position 84C, the user can change a video such that a video of a date and time corresponding to the user-designated position 84C is displayed on the video screen 81C.

When a user inputs an instruction to add the marking position 83 to the input device 71 with the display device 72 displaying a video of a certain timing, the video display tool 40 registers a date and time corresponding to that displayed video, as the marking position 83 in the second marking information 54.

When a user inputs an instruction to delete the marking position 83 to the input device 71 with the display device 72 displaying a certain video, the video display tool 40 deletes the marking position 83 of a date and time corresponding to that displayed video, from the second marking information 54.

Note that, as in the case of the program display tool 20, a user may add or delete the marking position 83 by designating a specific position on the video seek bar 80C.

For example, in a case where the program display tool 20 is the first display tool, the video display tool 40 is the second display tool. In this case, an area that displays the program screen 81A is a first display area, and an area that displays the video screen 81C is a second display area. Moreover, the user-designated position 84A is a first date and time, and the marking position 83 on the program seek bar 80A is a second date and time. The user-designated position 84C is a third date and time, and the marking position 83 on the video seek bar 80C is a fourth date and time. In addition, the marking position 83 on the program seek bar 80A is the first marking position, and the marking position 83 on the video seek bar 80C is the second marking position.

For example, in a case where the video display tool 40 is the first display tool, the waveform display tool 30 is the second display tool. In this case, the area that displays the video screen 81C is the first display area, and an area that displays the waveform screen 81B is the second display area. The user-designated position 84C is the first date and time, and the marking position 83 on the video seek bar 80C is the second date and time. The user-designated position 84B is the third date and time, and the marking position 83 on the mark display area 78B is the fourth date and time. In addition, the marking position 83 on the video seek bar 80C is the first marking position, and the marking position 83 on the mark display area 78B is the second marking position.

For example, in a case where the waveform display tool 30 is the first display tool, the program display tool 20 is the second display tool. In this case, the area that displays the waveform screen 81B is the first display area, and the area that displays the program screen 81A is the second display area. The user-designated position 84B is the first date and time, and the marking position 83 on the mark display area 78B is the second date and time. The user-designated position 84A is the third date and time, and the marking position 83 on the program seek bar 80A is the fourth date and time. In addition, the marking position 83 on the mark display area 78B is the first marking position, and the marking position 83 on the program seek bar 80A is the second marking position. Note that the first date and time to the fourth date and time may be displayed in any order.

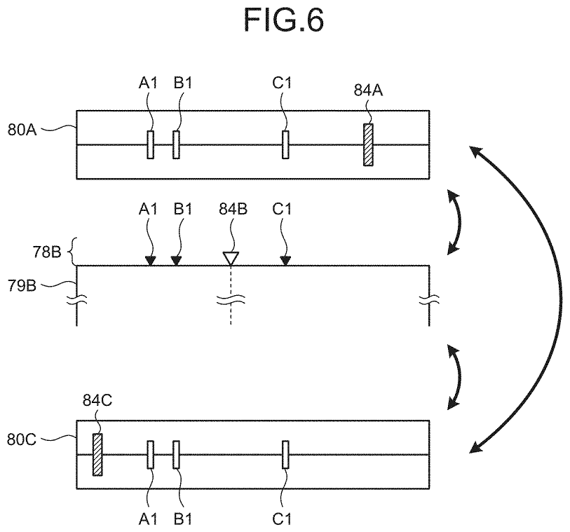

FIG. 6 is a diagram for explaining marking positions linked with one another by the data display controller according to the embodiment. FIG. 6 illustrates the program seek bar 80A of the program. screen 81A, the mark display area 78B of the waveform. screen 81B, and the video seek bar 80C of the video screen 81C.

In FIG. 6, the marking position 83 designated using the program display tool 20 is indicated by a marking position A1. The marking position 83 designated using the waveform display tool 30 is indicated by a marking position B1. The marking position 83 designated using the video display tool 40 is indicated by a marking position C1.

When a user designates the marking positions A1, B1, and C1, the marking positions A1 and B1 are stored in the first marking information 52, and the marking position C1 is stored in the second marking information 54.

The program display tool 20 reads the marking positions A1 and B1 from the first marking information 52, and reads the marking position C1 from the second marking information 54. As a result, the program display tool 30 causes the marking positions A1, B1, and C1 to be displayed simultaneously on the program seek bar 80A. Causing a plurality of marking positions to be displayed simultaneously means causing the plurality of marking positions to be displayed in the same display screen.

The waveform display tool 30 reads the marking positions A1 and B1 from the first marking information 52, and reads the marking position C1 from the second marking information 54. As a result, the waveform display tool 30 causes the marking positions A1, B1, and C1 to be displayed simultaneously in the mark display area 78B.

The video display tool 40 reads the marking positions A1 and B1 from the first marking information 52, and reads the marking position C1 from the second marking information. 54. As a result, the video display tool 40 causes the marking positions A1, B1, and C1 to be displayed simultaneously on the video seek bar 80C.

As described above, the data display controller 10 reflects the marking positions 83 designated by the individual tools, on these tools, thereby allowing the tools to link the marking positions 83 with one another.

Note that the program display tool 20 may display one or two of the marking positions A1, B1, and C1 on the program seek bar 80A. The waveform display tool 30 may display one or two of the marking positions A1, B1, and C1 in the mark display area 78B. The video display tool 40 may display one or two of the marking positions A1, B1, and C1 on the video seek bar 80C.

Moreover, the simultaneous display or the marking positions A1, B1, and C1 by the program display tool 20, the simultaneous display of the marking positions A1, B1, and C1 by the waveform display tool 30, and the simultaneous display of the marking positions A1, B1, and C1 by the video display tool 40 may be executed at different timings.

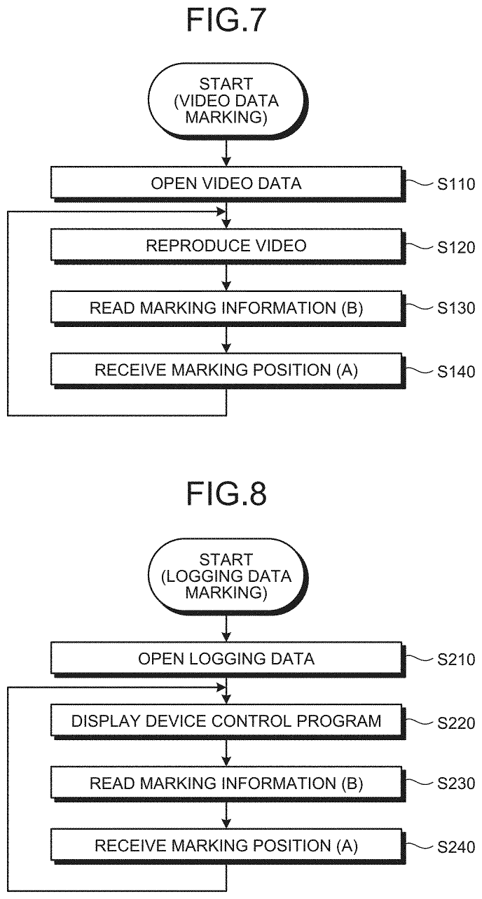

FIG. 7 is a flowchart illustrating a display processing procedure for the video display tool according to the embodiment to display the marking position. The video display tool 40 opens the video data 53 in accordance with an instruction from a user (step S110). The video display tool 40 thus reproduces a video of the video data 53 on the display device 72 (step S120).

The video display tool 40 reads marking information (step S130). The marking information read by the video display tool 40 is the first marking information 52 and the second marking information 54. The first marking information 52 is information created by the program display tool 20 and the waveform display tool 30, and the second marking information 54 is information previously created by the video display tool 40.

The video display tool 40 receives, from a user, an instruction to add or delete the marking position 83 (step S140). In the case of receiving the instruction to add the marking position 83, the video display tool 40 adds the marking position 83, which the video display tool 40 has been instructed to add, to the video seek bar 80C. In a case of receiving the instruction to delete the marking position 83, the video display tool 40 deletes the marking position 83, which the video display tool 40 has been instructed to delete, from the video seek bar 80C. The video display tool 40 repeats the processing of steps S120 to S140.

FIG. 8 is a flowchart illustrating a display processing procedure for the program display tool according to the embodiment to display the marking position. The program display tool 20 opens the logging data 51 in accordance with an instruction from a user (step S210). The program display tool 20 thus causes the display device 72 to display the device control program corresponding to the logging data 51 (step S220).

The program display tool 20 reads marking information (step S230). The marking information read by the program display tool 20 is the first marking information 52 and the second marking information 54. The first marking information 52 is information previously created by the program display tool 20 and the waveform display tool 30, and the second marking information 54 is information created by the video display tool 40.

The program display tool 20 receives, from a user, an instruction to add or delete the marking position 83 (step S240). In the case of receiving the instruction. to add the marking position 83, the program display tool 20 adds the marking position 83, which the program display tool 20 has been instructed to add, to the program. seek bar 80A. In the case of receiving the instruction to delete the marking position 83, the program display tool 20 deletes the marking position 83, which the program. display tool 20 has been instructed to delete, from the program seek bar 80A. The program display tool 20 repeats the processing of steps S220 to S240.

A display processing procedure of the marking position 83 by the waveform display tool 30 is similar to the display processing procedure of the marking position 83 by the program display tool 20, and thus will not be described.

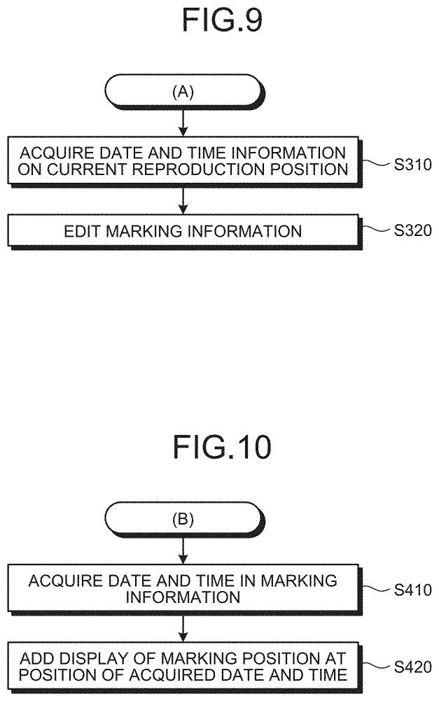

The processing in steps S140 and 5240 will be described. FIG. 9 is a flowchart illustrating a detailed. processing procedure for step S140 of FIG. 7 and step S240 of FIG. 8. Note that since the processing in step S140 of FIG. 7 is similar to the processing in step S240 of FIG. 8, the processing in 7140 of FIG. 7 will be described here.

When receiving, from the user, the instruction to add or delete the marking position 83, the video display tool 40 acquires a current date and time that is date and time information on. a current reproduction position. (step S310). The video display tool 40 edits the second marking information 54 in. accordance with the instruction. to add or delete the marking position 83 (step S320).

In the case of receiving the instruction to add the marking position 63, the video display tool 40 adds the current date and time to the second marking information 54. Note that in the case of receiving, from the user, an instruction to set a comment, the video display tool 40 registers a received comment in the second marking information 54 in association with the current date and time. In the case of receiving the instruct on to delete the marking position 83, the video display tool 40 deletes the marking position 83 of the current date and time from the second marking information 54.

FIG. 10 is a flowchart illustrating a detailed processing procedure for step S130 of FIG. 7 and step S230 of FIG. 8. Note that since the processing in step S130 of FIG. 7 is similar to the processing in step $230 of FIG. 8, the processing in step S130 of FIG. 7 will be described here.

The video display tool 40 acquires, from the marking information, a date and time indicating the marking position 83 (step S410). That is, the video display tool 40 acquires, from the first marking information 52, a date and time indicating the marking position 83, and acquires, from the second marking information 54, a date and time indicating the marking position 83.

The video display tool 40 adds display of the marking position 83 to a position of the acquired date and time on the video seek bar 80C (step S420). As a result, the video display tool 40 can cause the display device 72 to display the marking position 83 added by the user, the marking position 83 registered in the first marking information 52, and the marking position 83 registered in. the second marking information 54.

Note that each of the program display tool 20, the waveform display tool 30, and the video display tool 40 may execute one of the processing of displaying the marking position 83 designated by the user and the processing of registering, in the storage unit 50, the marking position 83 designated by the user earlier than the other processing.

Processing of adding the marking position 83, processing of registering a comment on the marking position 83, processing of displaying the registered comment, search processing within the marking information, and processing of displaying a search result will be described. The search processing within the marking information is search processing within the first marking information 52 and the second marking information 54. Note that these five types of processing are executed similarly for all of the program screen 81A, the waveform screen 81B, and the video screen 81C so that, here, a description will be made as to the data display controller 10 executing the above five types of processing on the program screen 81A.

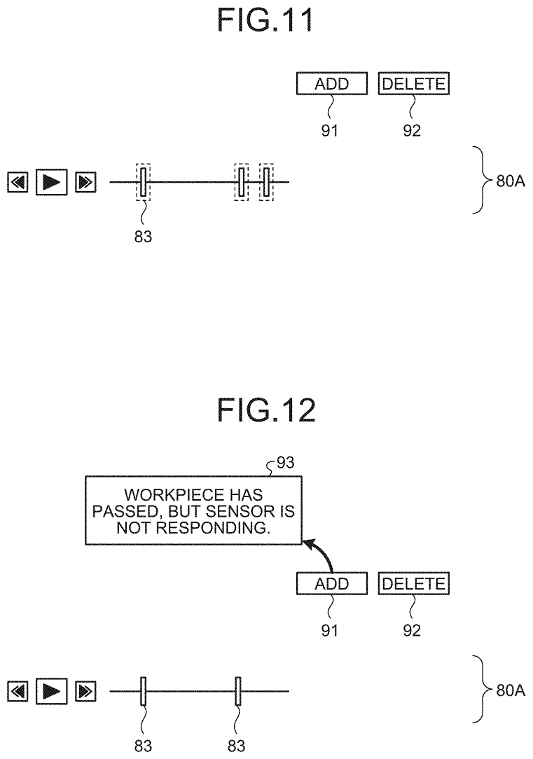

FIG. 11 is a diagram for explaining a marking position to be added or deleted by the data display controller according to the embodiment. In the program screen 81A, an add button 91 for adding the marking position 83 and a delete button 92 for deleting the marking position 83 are displayed near the program seek bar 80A or the like. When the add button 91 is pressed with a specific position on the program seek bar 80A designated or the specified program area 79A displayed, the program display tool 20 registers the designated position as the marking position 83. The program display tool 20 may register one, or two or more of the marking positions 83.

FIG. 12 is a diagram for explaining how the data display controller according to the embodiment registers a comment for the marking position. When the add button 91 display controller according to the embodiment registers a pressed, the program display tool 20 allows display of a comment input window 93 for inputting a comment corresponding to the marking position 83 to be added.

When the comment is input to the comment input window 93, the program display tool 20 registers the input comment and the marking position 83 to be added in the first marking information 52 in association with each other.

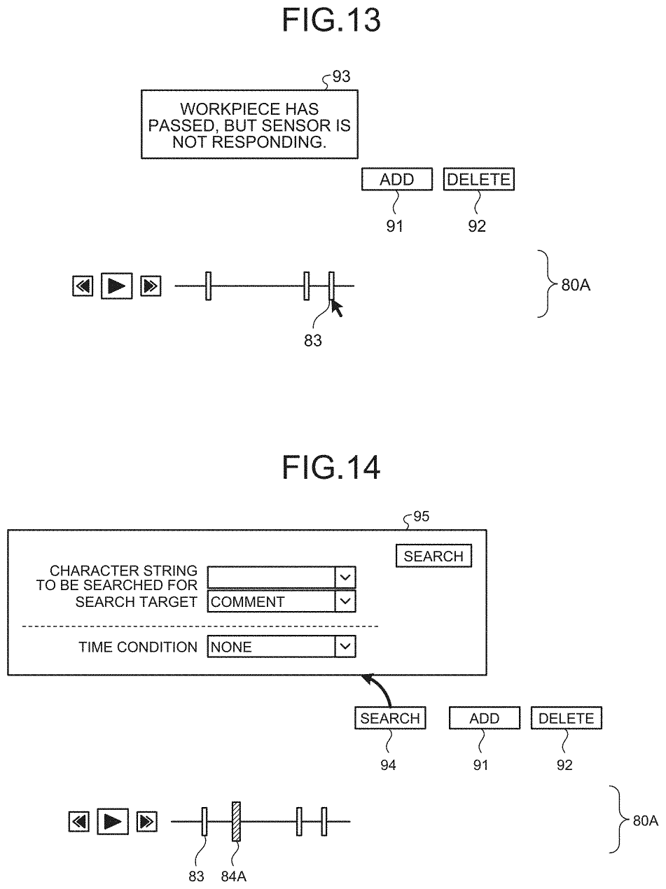

FIG. 13 is a diagram for explaining the processing for the data display controller according to the embodiment to display the registered marking position. When a cursor is placed on the marking position 83 displayed on the program seek bar 80A, the program display tool 20 allows display of the comment registered at the marking position 83 having the cursor placed thereon.

FIG. 14 is a diagram for explaining the search processing executed by the data display controller according to the embodiment. In the program screen 81A, a search button 94 is displayed near the program seek bar 80A or the like. The search button 94 is a button for searching for specific data from the first marking information 52 and the second marking information 54.

When the search button 94 is pressed, the program display tool 20 allows display of a search input window 95 for inputting data to be searched for and a search condition. In the search. input window 95, a character string to be searched for, a date and time to be searched for, and the like can be input. The program display tool 20 searches the first marking information 52 and the second marking information 54 for data corresponding to the information input in the search input window 95.

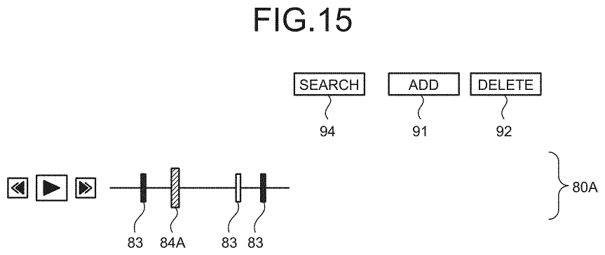

FIG. 15 is a diagram for explaining a processing result of the search processing executed by the data display controller according to the embodiment. When executing the search processing, the program display tool 20 extracts the marking position 83 associated with the data corresponding to the information input in the search input window 95. The program display tool 20 causes the program seek bar 80A to display the marking position 83 extracted as the processing result of the search processing. That is, the program display tool 20 searches the marking positions 83 for the marking position 83 that meets the condition designated by the user, and causes the program seek bar 80A to display the marking position 83 searched for. The program display tool 20 allows display of the extracted marking position 83, changing its color or the like such that the extracted marking position 83 can be distinguished from the rest of the marking positions 83.

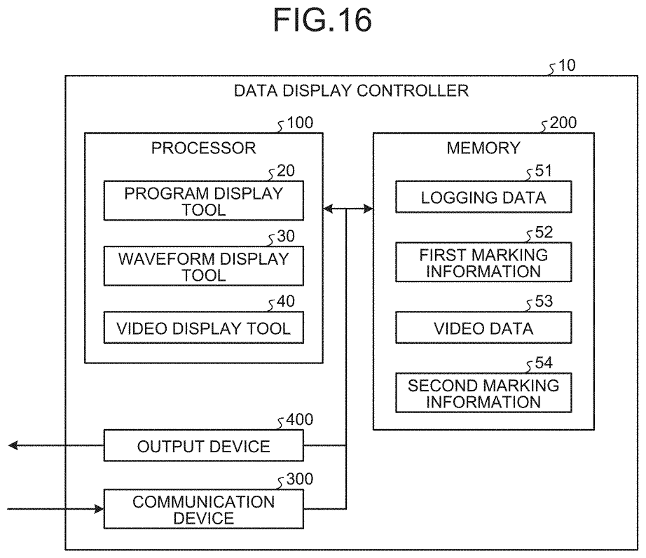

A hardware configuration of the data display controller 10 will be described. FIG. 16 is a diagram illustrating an example of the hardware configuration for implementing the data display controller according to the embodiment.

The data display controller 10 can be implemented by a communication device 300, a processor 100, a memory 200, and an output device 400. The processor 100 is, for example, a central processing unit. (CPU) or a system large scale integration. (LSI), the CPU being also referred to as a central processor, a processing unit, an arithmetic unit, a microprocessor, a microcomputer, or a digital signal processor (DSP). The memory 200 is, for example, a random access memory (RAM) or a read only memory (ROM).

The data display controller 10 is implemented by the processor 100 reading and executing a data display control program stored. in the memory 200 and executable by a computer for executing the operation of the data display controller 10. In other words, the data display control program as the program for executing the operation of the data display controller 10 causes the computer to execute a procedure or a method carried out by the data display controller 10.

The data display control program executed by the data display controller 10 has a module configuration. including the program display tool 20, the waveform display tool 30, and the video display tool 40, which tools are loaded on a main storage device and generated on the main storage device.

The communication device 300 receives the logging data 51 and the video data 53, and sends these data to the memory 200. The memory 200 is used as a temporary memory when the processor 100 executes various types of processing. The memory 200 stores the logging data 51, the first marking information 52, the video data 53, and the second marking information 54. The output device 400 outputs the logging data 51, the video data 53, the program seek bar 80A, the video seek bar 80C, the specified. program area 79A, the marking position 83, the user-designated positions 84A to 84C, the current date and time, and the like to the display device 72.

The data display control program may be stored in a computer-readable storage medium in a file in an installable format or an executable format, and provided as a computer program product. The data display control program may also be provided to the data display controller 10 via a network such as the Internet. Note that the functions of the data display controller 10 may be implemented partly by dedicated hardware such as a dedicated circuit and partly by software or firmware.

As described above, the program display tool 20 can display a change in the controlled state of the manufacturing device, and register a displayed time position as the marking position 83 when a user finds a point to focus on in the controlled state.

The waveform display tool 30 can display a change in a control signal of the manufacturing device as a waveform on a graph, and register a displayed time position as the marking position 83 when a user finds a point to focus on in the waveform on the graph.

The video display tool 40 can display a video, and register a displayed time position as the marking position 83 when a user finds a point to focus on in the video.

The program display tool 20 can read and display, on the program screen 81A, the marking position 83 registered by the waveform display tool 30 and the video display tool 40. Likewise, the waveform display tool 30 can read and display, on the waveform screen 81B, the marking position 83 registered by the program display tool 20 and the video display tool 40. Likewise, the video display tool 40 can read and display, on the video screen. 81C, the marking position 83 registered by the program. display tool 20 and the waveform display tool 30.

The present embodiment. has disclosed the case of setting and. registering the marking information with the logging data 51 and the video data 53, but the information to be set and registered need only be data acquired when a device such as the manufacturing device is controlled. For example, the present embodiment is also applicable to data on a base unit for controlling a device and data on an extension unit. Moreover, the data for setting and registering the marking information may be three or more types of data.

As described above, in the data display controller 10 of the embodiment, the program display tool 20 allows display of the data that changes over time and the marking position 83 which each of the waveform display tool 30 and the video display tool 40 received from a user. Each of the tools registers the marking position 83 received from the user in the storage unit 50. Then, each of the tools reads, from the storage unit 50, the marking position 83 registered by itself or another one of tools and allows display of that marking position. The data display controller 10 can thus easily allows display of data desired by the user among the plurality of types of data that changes over time.

As a result, the user can check a status of a trouble in the manufacturing device from the data displayed on the display device 72. The user can also mark a point to focus on in the data from the viewpoint of each data and check, on each tool, the data on that marked point. Accordingly, the user can perform troubleshooting on the basis of the data displayed on the display device 72, and can thus reduce the time required for troubleshooting.

The data display controller 10 allows each tool to separately mark the point to be focused, so that a plurality of users can take their different views on and share that marked point that is the marking position 83. Each user can therefore efficiently analyse data.

Moreover, since the data display controller 10 can cause each tool to display data on a different date and time, without changing the date and time of specific data, a user can change another piece of data to check a change thereof.

The data display controller 10 can also allow the waveform display tool 30 to display thereon waveform data on a date and time designated by a user even where a video is paused at the marking position 83.

The data display controller 10 can also allow the program display tool 20 to display thereon the internal data value of a date and time designated by a user even where a video is paused at the marking position 83.

Moreover, a user can check, on the program display tool 20, a control logic, changing the internal data value of the control program.

One piece of the logging data 51 and the video data 53 often have a plurality of points to focus attention on as such points can be factors of trouble. The data display controller 10 can set the marking position 83 for each point to be focused, and can allow immediately jumping to and display of each marking position 83. As a result, the data display controller 10 can skip other data that does not need checking than the point to be focused.

Moreover, the data display controller 10 can display the additional information such as the comment, whereby not only the date and time of the marking position 83 but also the intention of marking indicating a reason for marking can be included in the marking information and displayed. As a result, a user can perform quick analysis.

Moreover, the data display controller 10 can execute the search processing within the marking information and thus enables quick access to the marking position 83 targeted and desired by a user. As a result, the user can perform. quick analysis.

The configuration illustrated in the above embodiment merely illustrates an example, and can thus be combined with another known technique or partially omitted and/or modified without departing from the scope of the present disclosure.

### REFERENCE SIGNS LIST

1 data display system; 10 data display controller; 20 program display tool; 21, 31, 41 display control unit; 22, 32, 42 display position designating unit; 23, 33, 43 marking position designating unit; 24, 34, 44 marking information receiving unit; 25, 35, 45 marking information reading unit; 30 waveform display tool; 40 video display tool; 50 storage unit; 51 logging data; 52 first marking information; 53 video data; 54 second marking information; 60 communication unit; 71 input device; 72 display device; 78B mark display area; 79A specified program area; 79B specified waveform area; 79C video display area; 80A program seek bar; 80C video seek bar; 81A program screen; 81B waveform screen; 81C video screen; 82 date and time display area; 83 marking position; 84A to 84C user-designated position; 85 trigger position; 91 add button; 92 delete button; 93 comment input window; 94 search button; 95 search input window; 100 processor; 200 memory; 300 communication device; 400 output device; A1, B1, C1 marking position.

1. A non-transitory storage medium to store a data display control program that when executed by a processor, performs:
a storing process of storing stores first data and second data, the first data being data related to a manufacturing device in operation, and being time series data for a period of time including a first date and time;
a first display process of causing to be displayed in a first display area and, when a second date and time is designated within the first display area, causing a first marking position indicating the second date and time to be displayed in the first display area;
a first registration process of registering first marking information related to the first marking position;
a second display process of causing the second data to be displayed in a second display area, reading the registered first marking information, and causing the first marking position indicating the second date and time to be displayed in the second display area;
a third display process of causing the second data to be displayed in the second display area, the second data being data on the manufacturing device in operation for a period of time including a third date and time, and, when a fourth date and time is designated within the second display area, causing a second marking position indicating the fourth date and time to be displayed in the second display area;
a second registration process of registering second marking information related to the second marking position; and
a fourth display process of reading the registered second marking information and causing the second marking position to be displayed in the first display area, wherein
the first marking position and the second marking position are displayed in the first display area and the second display area, the first marking position and the second marking position being linked with each other.

2. (canceled)

3. The storage medium according to claim 1, wherein
the first marking position and the second marking position are displayed simultaneously in the first display area.

4. The storage medium according to claim 1, wherein
the first marking position and the second marking position are displayed simultaneously in the second display area.

5. The storage medium according to claim 1, wherein
the storing process includes storing logging data and video data, the logging data being logged control data used in controlling the manufacturing device, and the video data presenting a video of the manufacturing device,
a logging data value on a device control program used to control the manufacturing device is displayed in the first display area, the logging data value being included in the logging data, and
the video data is displayed in the second display area.

6. The storage medium according to claim 1, wherein
the storing process includes storing logging data and video data, the logging data being logged control data used in controlling the manufacturing device, and the video data presenting a video of the manufacturing device,
the video of the manufacturing device is displayed in the first display area, and
a waveform of the logging data is displayed in the second display area.

7. The storage medium according to claim 1, wherein
the storing process includes storing logging data, the logging data being logged control data used in controlling the manufacturing device,
a waveform of the logging data is displayed in the first display area, and
a logging data value on a device control program used to control the manufacturing device is displayed in the second display area, the logging data value being included in the logging data.

8. The storage medium according to claim 1, wherein
the first data and the second data of independent dates and times are displayed, without the first date and time of the first data and the third date and time of the second data being linked with each other.

9. The storage medium according to claim 1, wherein
the first marking position includes a plurality of first marking positions, and
the second marking position includes a plurality of second marking positions.

10. The storage medium according to claim 1, wherein
the first registration process includes registering the first marking position in association with first additional information, as the first marking information,
the second registration process includes registering the second marking position in association with second additional information, as the second marking information,
the first additional information includes at least one of a comment on the first marking position, a name of a reference document to be referred to regarding the first marking position, and information that identifies a user who provides an instruction to set the first marking position,
the second additional information includes at least one of a comment on the second marking position, a name of a reference document to be referred to regarding the second marking position, and information that identifies a user who provides an instruction to set the second marking position,
the first marking position and the first additional information are displayed in the first display area, and
the second marking position and the second additional information are displayed in the second display area.

11. The storage medium according to claim 1, wherein
the first marking position is searched for a first marking position that meets a condition designated by a user, and the first marking position searched for is displayed in the first display area, and
the second marking position is searched for a second marking position that meets a condition designated by a user, and the second marking position searched for is displayed in the second display area.

12. A data display control method comprising:
storing first data and second data, the first data being data related to a manufacturing device in operation, and being time series data for a period of time including a first date and time;
causing the first data to be displayed in a first display area and, when a second date and time is designated within the first display area, causing a first marking position indicating the second date and time to be displayed in the first display area;
registers registering first marking information related to the first marking position;
causing the second data to be displayed in a second display area, reads the registered first marking information, and causing the first marking position indicating the second date and time to be displayed in the second display area;
causing the second data to be displayed in the second display area, the second data being data on the manufacturing device in operation for a period of time including a third date and time and, when a fourth date and time is designated within the second display area, causing a second marking position indicating the fourth date and time to be displayed in the second display area;
registering second marking information related to the second marking position; and
reading the registered second marking information and causing the second marking position to be displayed in the first display area, wherein
the first marking position and the second marking position are displayed in the first display area and the second display area, the first marking position and the second marking position being linked with each other.

13. (canceled)

14. The data display control method according to claim 12 wherein
the first marking position and the second marking position are displayed simultaneously in the first display area.

15. The data display control method according to claim 12, wherein
the first marking position and the second marking position are displayed simultaneously in the second display area.

16. A data display controller comprising:
a memory to store first data and second data, the first data being data related to a manufacturing device in operation, and being time series data for a period of time including a first date and time;
first display circuitry to cause the first data to be displayed in a first display area and, when a second date and time is designated within the first display area, cause a first marking position indicating the second date and time to be displayed in the first display area, the first display circuitry registering first marking information related to the first marking position, in the memory; and
second display circuitry to cause the second data to be displayed in a second display area, read the first marking information from the memory, and cause the first marking position indicating the second date and time to be displayed in the second display area, wherein
the second display circuitry causes the second data to be displayed in the second display area, the second data being data on the manufacturing device in operation for a period of time including a third date and time and, when a fourth date and time is designated within the second display area, causes a second marking position indicating the fourth date and time to be displayed in the second display area, the second display circuitry registering second marking information related to the second marking position, in the memory,
the first display circuitry reads the second marking information from the memory and causes the second marking position to be displayed in the first display area, and
the first display circuitry and the second display circuitry cause the first marking position and the second marking position to be displayed in the first display area and the second display area, the first marking position and the second marking position being linked with each other.

17. (canceled)

18. The data display controller according to claim 16, wherein
the first display circuitry causes the first marking position and the second marking position to be displayed simultaneously in the first display area.

19. The data display controller according to claim 16, wherein
the second display circuitry causes the first marking position and the second marking position to be displayed simultaneously in the second display area.
